(19) United States
(12) Patent Application Publication
(10) Pub. No.: US 2021/0169615 A1
(43) Pub. Date: Jun. 10, 2021

(54) REINFORCED CERAMIC ORTHODONTIC BRACKET

(71) Applicant: KING SAUD UNIVERSITY, Riyadh (SA)

(72) Inventor: RAHAF NAIM ZAWAWI, RIYADH (SA)

(21) Appl. No.: 16/708,392

(22) Filed: Dec. 9, 2019

(51) Int. Cl. A61C 7/14

(52) U.S. Cl. CPC A61C 7/141; A61C 2201/002; A61C 7/148

(57) ABSTRACT

The reinforced ceramic orthodontic bracket is a ceramic bracket reinforced with a metal base. The bracket is bonded to a user's tooth and accepts an alignment wire for adjusting an orientation of the tooth based on forces provided by the alignment wire. A tooth-contacting side of the bracket includes a metal base to counteract the relatively low tensile strength and ductility of the ceramic. An opaque layer is included between the ceramic and metal base for masking the color of the metal so that the bracket blends in with the natural color of the tooth.

### BACKGROUND

### 1. Field

The present disclosure relates to orthodontic brackets, and in particular, to a reinforced ceramic orthodontic bracket, the bracket being reinforced with a metal backing.

### 2. Description of the Related Art

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct an underbite or an overbite. For example, orthodontic treatment can improve the patient's occlusion and/or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth, or alternatively, for attachment to bands, which are, in turn, cemented or otherwise secured around the teeth. Once the brackets are affixed to the patient's teeth, such as by means of glue or cement, a curved arch wire is inserted into slots in the bracket. The arch wire acts as a template or track to guide movement of the teeth into proper alignment. End sections of the arch wire are typically captured within tiny appliances known as tube brackets or terminal brackets, which are affixed to the patient's bicuspids and/or molars. The remaining brackets typically include open arch wire slots and apply orthodontic forces by means of ligatures attached to the brackets and arch wire (e.g., by means of tie wings on the brackets).

Orthodontic treatment is traditionally performed using metallic brackets. With the continuously increasing demand for orthodontic treatment among adults, the aesthetic preferences of orthodontic applicants have received increased emphasis. Accordingly, more aesthetic orthodontic appliances, including ceramic brackets and clear aligners, have been recently introduced.

Although ceramic is biocompatible, rigid, and has greater aesthetic appeal than metal appliances, it is a brittle material with low ductility. These characteristics may result in enamel damage or bracket fracture when removing/debonding the ceramic bracket from the tooth.

Thus, an orthodontic bracket solving the aforementioned problems is desired.

### SUMMARY

The reinforced ceramic orthodontic bracket includes a ceramic body reinforced with a metal backing. The bracket attaches to a user's tooth and accepts an alignment wire for adjusting the orientation of the tooth based on forces provided by the alignment wire. A tooth contacting side of the bracket may include a metal plate to counteract the relatively low tensile strength and ductility of the ceramic. An opaque layer may be included between the ceramic and the metal plate to mask the color of the metal so that the bracket blends in with the natural color of the tooth.

A method of making the orthodontic bracket includes sintering the ceramic body, the opaque layer, and the metal plate together, resulting in bonds between the layers that do not rely upon adhesive.

These and other features of the present disclosure will become readily apparent upon further review of the following specification and drawings.

### BRIEF DESCRIPTION OF THE DRAWINGS

FIG. 1 shows a front view of a reinforced ceramic orthodontic bracket.

FIG. 2 shows a back view of the orthodontic bracket of FIG. 1

FIG. 3 shows a perspective view of the orthodontic bracket of FIG. 1 as seen from the side of the bracket.

FIG. 4 shows an exploded perspective view of an alternative embodiment of a reinforced ceramic orthodontic bracket.

Similar reference characters denote corresponding features consistently throughout the attached drawings.

### DETAILED DESCRIPTION OF THE PREFERRED EMBODIMENTS

The reinforced ceramic orthodontic bracket is a ceramic bracket reinforced with a metal backing. The bracket may be dimensioned and configured similar to orthodontic brackets known in the art for attachment to a user's teeth that receive an alignment wire for aligning the teeth. A tooth-contacting side of the bracket includes a metal reinforcement to counteract the relatively low tensile strength and ductility of the ceramic for bonding/debonding the bracket to and from the teeth. An opaque layer may be included between the ceramic and metal reinforcement for masking the color of the metal so that the bracket blends in with the natural color of the tooth.

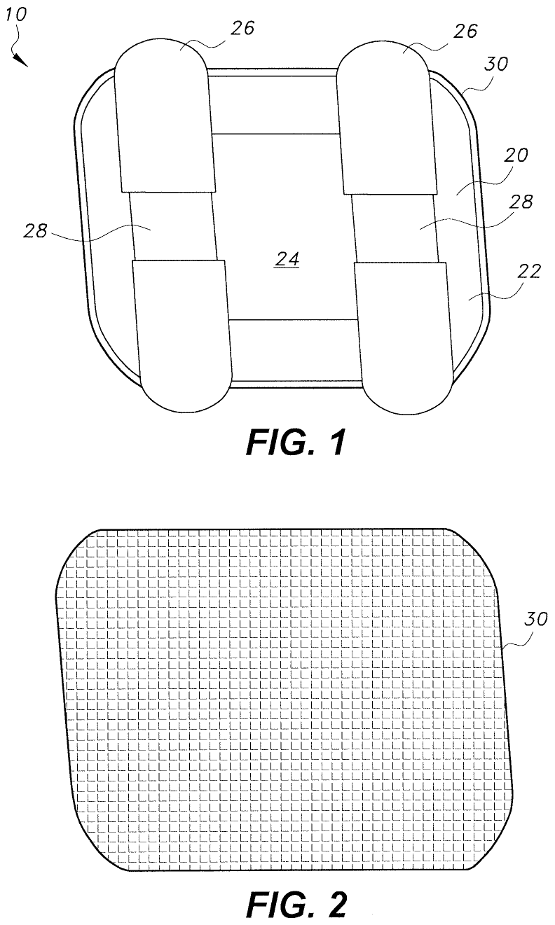

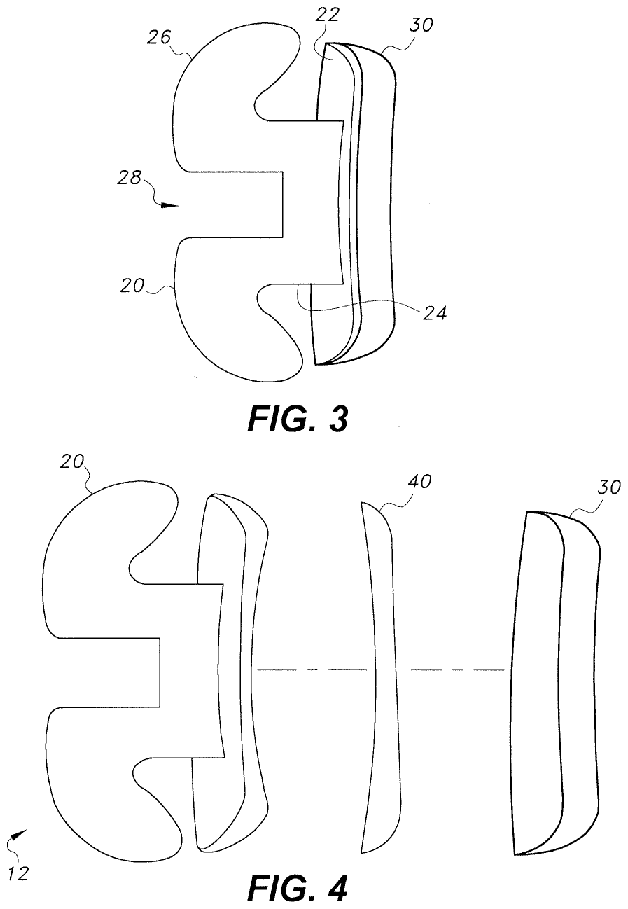

FIGS. 1-3 show a first embodiment of the bracket 10, which includes a ceramic body 20 defining a base 22 and a wire guide 24. The wire guide 24 provides two parallel walls 26 having aligned slots 28 for accepting an alignment wire. The base 22 of the bracket 10 provides an arcuate tooth-facing surface (shown in FIG. 3). The arcuate tooth-facing surface of the base 22 may be designed to match the shape of the tooth for which it is intended to be attached. The ceramic body 20 is a unitary component made of crystalline alumina. The crystalline alumina may be polycrystalline when a more opaque body is desired or monocrystalline when a more translucent body is desired.

A metal base 30 is attached to the tooth-facing side of the ceramic body 20. The metal base 30 may completely cover the tooth facing surface of the ceramic body 20. In some embodiments, as shown in FIGS. 2 and 3, the metal base 30 may have a larger area than the tooth-facing surface of the ceramic body 20, resulting in the metal base extending past the peripheral edge of the ceramic body 20 (shown in FIGS. 1 and 3). The metal base 30 may be a plate, a surface coating, a pad, or other metal reinforcement. A tooth-facing side of the metal base 30 may define a cross-hatched, mesh, or knurled pattern (shown in FIG. 2) and/or may be provided with micro-roughness by grinding, milling, etching with hydrogen fluoride or other strong acid, or other abrading processes to increase surface area for bonding. The cross-hatched pattern may be provided by indentations or projections of the cross-hatching. The metal base 30 may be made from any biocompatible metal with sufficient hardness that it may be bonded to a tooth and removed without damaging tooth enamel and without fracturing, e.g., stainless steel. The metal base 30 reinforces the ceramic base 20 to allow for removal from a user's tooth using conventional orthodontic removal pliers without damaging the bracket or the tooth enamel, thereby allowing rebonding and recycling the bracket 10 (if needed) using conventional techniques known in the art.

FIGS. 3-4 show a second embodiment of a bracket 12. The bracket 12 includes a ceramic body 20 and metal base 30, similar to the first embodiment. An opaque pad 40 is provided between the ceramic body 20 and the metal base 30. The opaque pad 40 may prevent the color of the metal base 30 from being transmitted through the ceramic body 20, thereby improving the aesthetic appearance of the bracket 12. The opaque pad 40 may completely cover the ceramic body-facing surface of the metal base 30. The opaque pad 40 may be made of zirconia or a polymer. If a polymer is used, it may enhance the removal/debonding force transition from metal to ceramic referring to polymer flexibility.

The ceramic body 20 and metal base 30 may be bonded together using both chemical and physical bonds. A method of making the bracket 12 may include roughening the tooth-facing surface of the ceramic body 20 and the ceramic body-facing surface of the metal base 30. The ceramic body 20 may be roughened using acid etching, sand blasting, or other methods known in the art. The metal base 30 may be roughened using sand blasting, acid etching, or other methods known in the art, followed by heat treatment for oxidizing the metal surface. The roughened surfaces may be bonded by forcing the surfaces together while heating in a sintering process. During the sintering process, the ceramic will partially dissolve and be saturated with the metal oxide, resulting in a chemical bond between the two surfaces. As a result, the metal base 30 and the ceramic body 20 will be bonded without the use of an adhesive that may be susceptible to failure and degradation. In embodiments using zirconia as an opaque layer 40, a thin layer may be painted on the roughened and oxidized metal base 30 and heated under a vacuum to prevent voids. The metal base 30 and zirconia/polymer 40 component may then be attached to the ceramic body 20 using the previously discussed sintering process.

It is to be understood that the reinforced ceramic orthodontic bracket is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A reinforced ceramic orthodontic bracket, consisting of:
a ceramic body, the ceramic body consisting of a base and parallel walls defining a wire guide, the base having an arcuate tooth-facing surface;
an opaque pad consisting of a ceramic body-facing surface and an opposite tooth-facing surface, the ceramic body-facing surface of the opaque pad being attached to the tooth-facing surface of the ceramic body, wherein the opaque pad is bonded directly to the ceramic body; and
an imperforate metal base consisting of an opaque pad-facing surface and an opposite tooth-facing surface, the opaque pad-facing surface of the metal base is bonded directly to the tooth-facing surface of the opaque pad, wherein each of the directly bonded surfaces is sintered.

2-4. (canceled)

5. The reinforced ceramic orthodontic bracket of claim 1, wherein the tooth-facing surface of the opaque pad and the tooth-facing surface of the metal base have a greater area than the tooth-facing surface of the ceramic base.

6. The reinforced ceramic orthodontic bracket of claim 1, wherein the metal base extends past a peripheral edge of the tooth-facing surface of the ceramic body.

7. The reinforced ceramic orthodontic bracket of claim 1, wherein the opaque pad is positioned to prevent the metal base from being seen through the ceramic body, thereby improving aesthetic appearance of the bracket.

8. The reinforced ceramic orthodontic bracket of claim 7, wherein the opaque pad is made of zirconia.

9. The reinforced ceramic orthodontic bracket of claim 7, wherein the opaque pad is made of polymer material.

10. The reinforced ceramic orthodontic bracket of claim 1, wherein the wire guide comprises aligned slots defined in the two parallel walls, the slots being adapted for accepting an alignment wire.

11. The reinforced ceramic orthodontic bracket of claim 1, wherein the tooth-facing surface of the metal base defines a cross-hatched pattern.

12. The reinforced ceramic orthodontic bracket of claim 1, wherein the tooth-facing surface of the metal base defines a knurled texture.

13. The reinforced ceramic orthodontic bracket of claim 1, wherein the tooth-facing surface of the metal base defines a mesh.
